(19) United States
(12) Patent Application Publication
(10) Pub. No.: US 2001/0030199 A1
(43) Pub. Date: Oct. 18, 2001

(54) Quick removal hinge assembly

(76) Inventor: James David DiRocco, Delmar, DE (US)

Correspondence Address: Warren B. Kice, Haynes and Boone, LLP, Suite 3100, 901 Main Street, Dallas, TX, 75202-3789, US

(21) Appl. No.: 09/848,480

(22) Filed: May 3, 2001

Related U.S. Application Data
(62) Division of application No. 09/425,781, filed on Oct. 25, 1999.
Application No. 09/425,781 is a division of application No. 09/097,443, filed on Jun. 15, 1998, now abandoned.

(51) Int. Cl. B67D 5/16

(52) U.S. Cl. 222/71; 222/74

(57) ABSTRACT

A housing in which a first hinge member is disposed on an enclosure and has a curved surface. A second hinge member is disposed on a door for the housing and also has a curved surface. The respective curved surfaces of the hinge members interlock to connect the door to the enclosure while permitting relatively pivotal movement therebetween and quick and easy removal of the door from the housing.

### BACKGROUND OF THE INVENTION

This invention relates to a hinge assembly and, more particularly, to an assembly that pivotally connects a door to a housing while permitting quick removal of the door from the housing.

There are many application involving a door that is hinged to a housing, or the like, and designed to pivot, or swing from a vertical closed position to an open position in which the door extends horizontally and outwardly from the housing. However, in most of these cases, when the door is opened to its horizontal position, access to the interior of the housing is difficult since stretching across the projecting door requires a long reach and places an individual in an awkward position to gain access to the rearmost portions of the interior of the housing.

In an attempt to solve these problems, various techniques have been proposed to permit complete removal of the door. These techniques, however, cause other additional design problems. For example, even though they may include a hinge assembly that permits the door to be easily removable, the normal operation of the hinge assembly is often compromised and or the door sometimes inadvertently becomes disconnected from the housing. Also, since some hinge assemblies are spring biased toward the housing, removal of the door often removes the counter-balancing force exerted by the weight of the door on the spring. This can cause the hinge assembly to abruptly spring back towards the housing and thus creates a hazardous condition for the user. Further, many hinge assemblies of this type consist of a relatively high number of parts which adds to the complexity and cost of the assembly and reduces its reliability.

Therefore, what is needed is a hinge that permits the door to be removed in a easy and quick manner without compromising the normal operation of the hinge. Also, what is needed is a hinge assembly of the above type that insures that the door will not become inadvertently disconnected from the housing, and that removal of the door will not cause a hazardous condition. Further, a hinge of the above type is needed that has a minimum of components and is relatively inexpensive and easy to assemble.

### SUMMARY OF THE INVENTION

Therefore the present invention is designed to pivotally connect two members and includes a first hinge member disposed on a first member and having a curved surface. A second hinge member is disposed on the second member and also has a curved surface. The respective curved surfaces of the hinge members interlock to connect the first and second members while permitting relatively pivotal movement therebetween.

According to an example of the above, the first member is in the form of an enclosure and the second member would be a door for the enclosure. The hinge members of the present invention maintain the door secured to the enclosure in a positive and reliable manner for normal operation, yet allow the door to be pivoted to an open position and readily removed from the enclosure without compromising the hinged connection or causing the possibility of inadvertent removal of the door. Also, the hinges of the present invention eliminate any hazard caused by removal of the door, yet includes a minimum of components and is relatively inexpensive and easy to assemble.

### BRIEF DESCRIPTION OF THE DRAWINGS

FIG. 1 is an isometric view of a gas dispensing station that includes an electronics housing incorporating the hinge assembly of the present invention

FIG. 2 is an enlarged isometric view of the electronics housing of FIG. 1

FIGS. 3-6 are enlarged, partial, isometric views of the hinge assembly of FIG. 2 shown in various stages of assembly

### DESCRIPTION OF THE PREFERRED EMBODIMENT

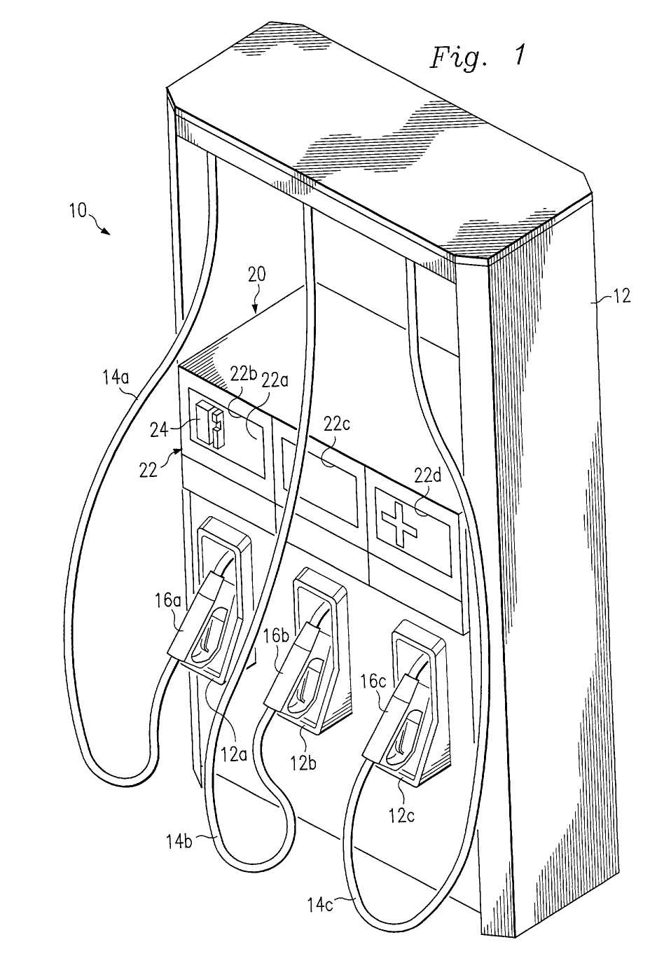

The hinge assembly of the present invention will be shown and described, for the purpose of example, in connection with a gasoline dispensing station, shown in general by the reference numeral 10 in FIG. 1 of the drawings. The station 10 consists of a rectangular housing 12 containing three boots 12a, 12b, and 12c. Three hoses 14a, 14b and 14c extend from the interior of the housing 12 where each are connected at one end to piping (not shown) extending from underground storage tanks and through the housing to permit gasoline to be dispensed from the station 10. Three dispensing nozzles 16a, 16b, and 16c are connected to the other ends of the hoses 14a, 14b, and 14c, respectively, for dispensing the gasoline into tanks of vehicles and are supported in the boots 12a, 12b, and 12c, respectively, when not in use

A self-contained electronics enclosure 20 is provider in the housing 12 of the station 10 and can be bolted thereto in a manner to be described. The enclosure 20 contains an array of electronics associated with dispensing of the gasoline and calculating and computing the cost of same, in a conventional manner. The enclosure 20 includes a door 22 defined in part by a face plate 22a having three windows 22b, 22c, and 22d formed therein. A card reader 24 is mounted in the window 22b to receive the customer's credit card, and the windows 22c and 22d are provided for displaying various aspects of the transaction, including, for example, cost per gallon of gasoline, the amount of gallons dispensed, and the total sale price, all in a conventional manner. The electronics associated with the card reader 24, and the display devices associated with the windows 22c and 22d are disposed in the enclosure 20.

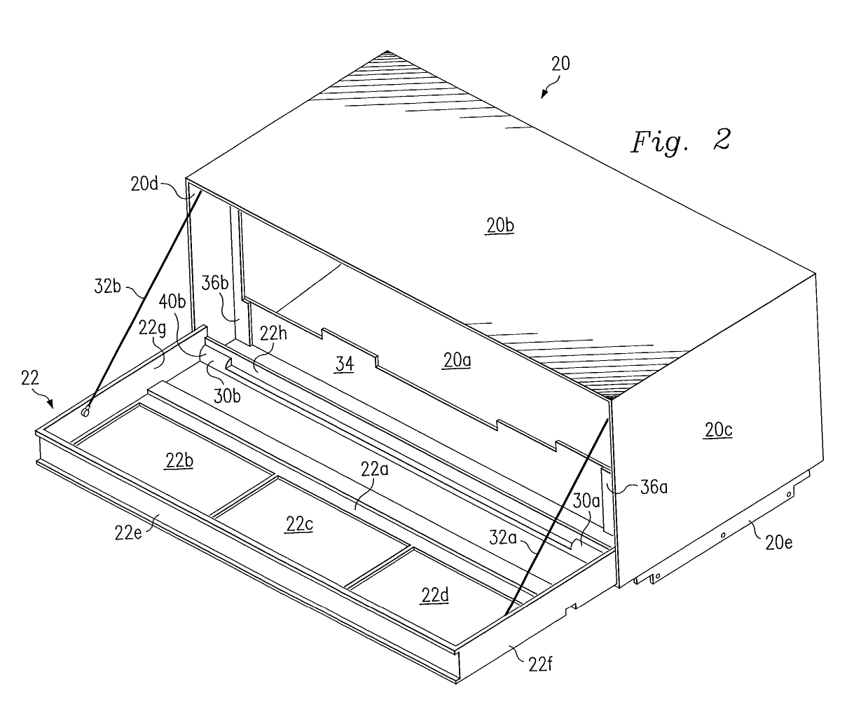

The enclosure 20 is shown in FIG. 2 with the door 22 opened. In addition to the main face plate 22a, the door 22 also includes a top plate 22e, a pair of side wall plates 22f and 22g, and a bottom plate 22h, all of which extend from, and perpendicular to, the face plate 22a

The hinge assembly of the present invention permits swinging, or pivotal, movement of the door 22 from its vertically-extending, closed position shown in FIG. 1, to its horizontally-extending, open position of FIG. 2. To this end, the hinge assembly includes a pair of spaced, raised, hollow, bosses 30a and 30b formed integrally with the rear surface of the race plate 22a of the door 22 near its lower edge portion, and at the junction of the latter portion and the bottom plate 22h of the door. Each of the bosses 30a and 30b is formed by a circular plate that thus defines a hollow interior having a curved cross section. The purpose and function of the bosses 30a and 30b will be described in detail. A pair of steel cables, 32a and 32b support the door 22 in its open position and each cable is fastened at one end to the interior of the door and at the other end to the interior or the enclosure 20, in any conventional manner

The enclosure includes a bottom plate 20a, a top plate 20b, two side plates 20c and 20d and a rear plate (not shown). The respective ends of the bottom plate 20 are extended and bent downwardly, as viewed in FIG. 2, to form two mounting flanges, one of which is shown by the reference numeral 20e, for mounting and securing the enclosure 20 to the housing 12 (FIG. 1) of the dispensing station 10

A mounting board 34 is disposed in the front portion of the enclosure 20, is mounted to, and extends upwardly from, the bottom plate 20, and is connected to the bottom plate in any conventional manner. The mounting board 34 receives various electronics (not shown) associated with the card reader 24, the display devices discussed above, and other electronics associated with the dispensing of gasoline from the station 10. It is understood that additional mounting boards can be mounted in the enclosure in the same manner as the board 34 A pair of elongated gaskets 36a and 36b are mounted at the ends of the mounting board 34 for engagement by the leading edges of the side plates 22f and 22g, respectively, of the door 22 in its closed position shown in FIG. 1, to prevent the ingress of fluids into the interior of the enclosure 20.

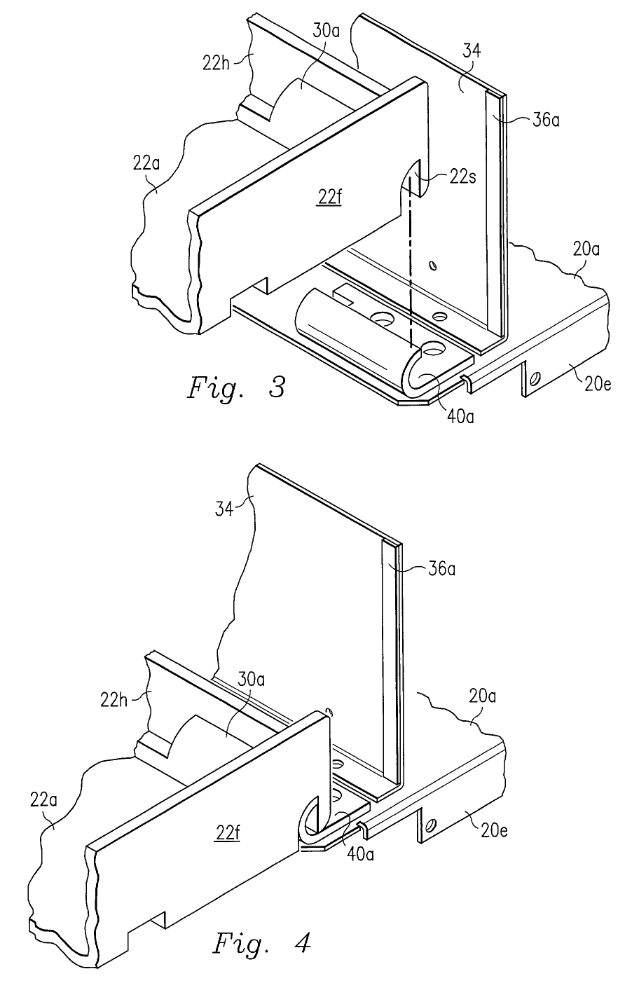

FIG. 3 shows the initial step in assembling the door 22 to the enclosure 20. In this respect, a slot 22s in formed in the rear portion of the side wall 22f of the door 22 which has a profile with a curved portion that is identical to a curved portion defined by the interior of the boss 30a for reasons to be described. Although not shown in the drawings it is understood that a similar slot is formed in the rear portion of the side wall 22g and has a curved portion identical to the curved portion defined by the interior of the boss 30b (FIG. 2)

The hinge assembly of the present invention also includes a hinge member 40a attached to the upper surface of the front end portion of the bottom plate 20a of the enclosure 20 in any conventional manner. The hinge member 40a has the same length as, and is in alignment with, the boss 30a of the door 22 and has a substantially “J” shaped cross section with its curved portion corresponding to the curved portions of the boss 30a and the slot 22s. Although not shown in FIG. 3, a hinge member 40b, partially shown in FIG. 2, is provided which is identical to the hinge member 40a and is also connected to the bottom plate 20a in a spaced relation to the hinge member 40a and in alignment with the boss 30b of the door 22. An initial step in connecting the door 22 to the hinge assembly involves locating the door as shown in FIG. 3, in which it extends slightly above the bottom plate 20a of the enclosure 20, with the bosses 30a and 30b in alignment with the hinge members 40a and 40b, respectively.

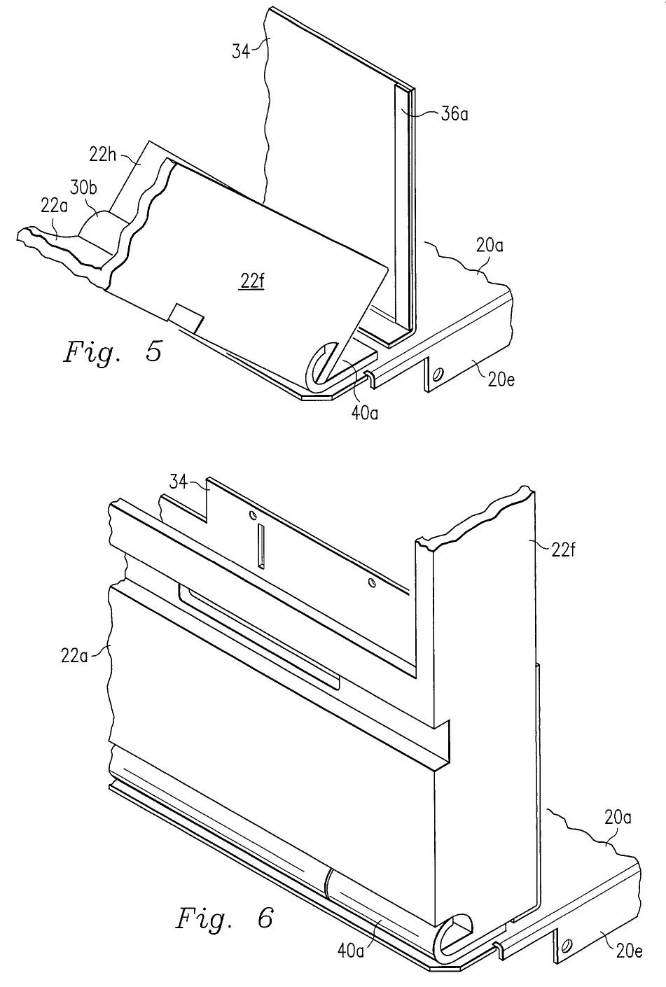

The door 22 is then lowered towards the bottom plate 20a of the enclosure 20 until the lower surface of the lower end portion of the door engages the corresponding upper surface of the bottom plate 20 as shown in FIG. 4. In this position, the hinge members 40a and 40b are interlocked with their respective bosses 30a and 30b, with the curved surfaces of the hinge members 40a and 40b in engagement with the corresponding cured surfaces of the bosses 30a and 30b as well as the corresponding slots, including the slot 22s formed in the side plates 22f and 22g, respectively. The upper end portion of the door 22 is then pivoted upwardly relatively to the enclosure 20 through an intermediate position shown in FIG. 5 and then to the final closed position shown in FIG. 6. In this closed position, the bosses 30a and 30b remain in engagement with their corresponding hinge members 40a and 40b as well as the slots in the respective side plates 22f and 22g, including the slot 22s. Also in this closed position, the pressure between the corresponding curved surfaces of the hinge members 40a and 40b and their respective bosses 30a and 30b keep the side plates 22f and 22g of the door 22 pushed against the gaskets 36a and 36b thus creating a seal

In the event it is desired to open the door to the positions of FIGS. 2 and 4, the above pivoting movement is reversed an the interlocking curved portions of the hinge members 40a and 40b and their respective bosses 30a and 30b keep the door in place. According to a feature of the invention, if it is desired to remove the door 22 from the enclosure 20 to permit better access to the interior of the enclosure 20, the door is pivoted to its horizontal position of FIGS. 2 and 4 and then simply lifted, or pulled, away from the hinge members 40a and 40b until the bosses 30a and 30b clear the hinge members.

Several advantages thus result from the hinge assembly of the present invention. For example, it maintains the door 22 secured to the enclosure 20 in a positive and reliable manner for normal operation, yet allows the door to be readily removed without compromising the hinge assembly or causing the possibility of inadvertent removal of the door. Also, the hinge assembly of the present invention eliminates any hazard caused by removal of the door 23, yet includes a minimum of components and is relatively inexpensive and easy to assemble.

It is understood that variations may be made the above without departing from the scope of the invention. For example, the present invention is not limited to use with an electronics housing in a gasoline dispensing station, but rather is equally applicable to pivotally connect any two members. Also, the present invention is not limited to two hinge members 40a and 40b and two corresponding bosses 30a and 30. Rather, one relatively long hinge member and boss could be provided, or three or more hinge members and corresponding bosses could be provided. Further, the enclosure 20 and the door 22 could be oriented in different planes so that the door is not limited to movement from a vertical position to a horizontal position and is not removable from the enclosure by lifting it upwardly.

It is understood that other modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. In combination, a first member, a first hinge member disposed on the first member and having a curved surface a second member, and a second hinge member disposed on the second member and having a curved surface, the respective curved surfaces of the hinge members interlocking to connect the first and second members while permitting relatively pivotal movement therebetween.

2. The combination of claim 1 wherein the second member is pivotal relative to the first member from first position in which it extends in the same plane as the first member to a second position in which it extends perpendicular to the first member, and wherein the second member can be moved out of connection with the first member by pivoting the second member to the first position and pulling the second member away from the first member to disengage the curved surfaces.

3. The combination of claim 1 wherein the first member is fixed and the second member pivots relative to the first member.

4. The combination of claim 3 wherein the first hinge member is attached to the first member and the second hinge member is formed integrally with the second member

5. The combination of claim 3 wherein the first hinge member is a curved plate attached to the first member, and wherein the second hinge member is a boss formed integrally with the second member and defining an internal curved surface.

6. The combination of claim 3 wherein the first member is a enclosure and the second member is a door for the enclosure which pivots relative to the enclosure from a closed position to a open position.

7. The combination of claim 1 further comprising an additional hinge member disposed on the first member and an additional hinge member disposed on the second member, the additional hinge members having curved surfaces that interlock to further connect the first and second members and permit the pivotal movement.

8. The combination of claim 3 wherein the first hinge member is disposed at one end of the first member, and wherein the second hinge member is disposed at one end of the second member, and wherein the other end of the second member is movable to and from the other end of the first member.

9. The combination of claim 8 wherein the respective curved surfaces of the hinge members are designed so that the second member can be removed from the first member by pivoting the other end of the second member away from the other end of the first member and then pulling the second member away from the first member.

10. A housing comprising an enclosure, a first hinge member disposed on the enclosure and having a curved surface, a door, and a second hinge member disposed on the door and having a curved surface, the respective curved surfaces of the hinge members interlocking to connect the door to the enclosure while permitting relatively pivotal movement therebetween.

11. The housing of claim 10 wherein the door is pivotal relative to the enclosure from an open position to a closed position in which it extends perpendicular to the enclosure, and wherein the door can be moved out of connection with the enclosure by pivoting the door to the open position and pulling the door away from the enclosure to disengage the curved surfaces

12. The housing of claim 11 wherein the respective curved surfaces of the hinge members are adapted to permit the door to be removed from the housing by pivoting the door to its open position and then pulling the door away from the enclosure.

13. The housing of claim 10 wherein the first hinge member is attached to the enclosure and the second hinge member is formed integrally with the door.

14. The housing of claim 13 wherein the first hinge member is a curved plate attached to the enclosure, and wherein the second hinge member is a boss formed integrally with the door and defining an internal curved surface

15. The housing of claim 10 further comprising an additional hinge member disposed on the enclosure and an additional hinge member disposed on the door, the additional hinge members having curved surfaces that interlock to further connect the door to the enclosure and permit the pivotal movement.

16. A gasoline dispensing system comprising a dispenser housing, at least one hose extending from the housing for connection to a source of gasoline, a nozzle connected to the hose for dispensing gasoline, and an enclosure connected to the housing for containing electronics associated with the dispensing, of the gasoline, a first hinge member disposed on the enclosure and having a curved surface, a door, and a second hinge member disposed on the door and having a curved surface, the respective curved surfaces of the hinge members interlocking to connect the door to the enclosure while permitting relatively pivotal movement therebetween.

17. The dispensing system of claim 16 wherein the door is pivotal relative to the enclosure from an open position to a closed position in which it extends perpendicular to the enclosure, and wherein the door can be moved out of connection with the enclosure by pivoting the door to the open position and pulling the door away from the enclosure to disengage the curved surfaces.

18. The dispensing system of claim 17 wherein the respective curved surfaces of the hinge members are adapted to permit the door to be removed from the housing by pivoting the door to its open position and then pulling the door away from the enclosure.

19. The dispensing system of claim 16 wherein the first hinge member is attached to the enclosure and the second hinge member is formed integrally with the door.

20. The dispensing system of claim 19 wherein the first hinge member is a curved plate attached to the enclosure, and wherein the second hinge member is a boss formed integrally with the door and defining an internal curved surface.

21. The dispensing system of claim 16 further comprising an additional hinge member disposed on the enclosure and an additional hinge member disposed on the door, the additional hinge members having curved surfaces that interlock to further connect the door to the enclosure and permit the pivotal movement.
